(19) United States
(12) Patent Application Publication
(10) Pub. No.: US 2005/0131946 A1
(43) Pub. Date: Jun. 16, 2005

(54) Method and apparatus for identifying hierarchical heavy hitters in a data stream

(76) Inventors: Philip Korn, New York, NY (US); Shanmugavelayutham Muthukrishnan, Washington, DC (US); Divesh Srivastava, Summit, NJ (US); Graham Cormode, Highland Park, NJ (US)

Correspondence Address: AT&T CORP., P.O. BOX 4110, MIDDLETOWN, NJ, 07748, US

(21) Appl. No.: 10/802,605

(22) Filed: Mar. 17, 2004

Related U.S. Application Data
(60) Provisional application No. 60/461,650, filed on Apr. 9, 2003.

(51) Int. Cl. G06F 17/00

(52) U.S. Cl. 707/104.1

(57) ABSTRACT

A method, apparatus, and computer readable medium for processing a data stream is described. In one example, a set of elements of a data stream are received. The set of elements are stored in a memory as a hierarchy of nodes. Each of the nodes includes frequency data associated with either an element in the set of elements or a prefix of an element in the set of elements. A set of hierarchical heavy hitters is then identified among the nodes in the hierarchy. The frequency data of each of the hierarchical heavy hitter nodes, after discounting any portion thereof attributed to a descendent hierarchical heavy hitter node in said set of hierarchical heavy hitter nodes, being greater than or equal to a fraction of the number of elements in the set of elements.

### CROSS-REFERENCE TO RELATED APPLICATIONS

This application claims benefit of U.S. provisional patent application Ser. No. 60/461,650, filed Apr. 9, 2003, which is herein incorporated by reference.

### BACKGROUND OF THE INVENTION

1. Field of the Invention

The present invention generally relates to processing data streams and, more particularly, to identifying hierarchical heavy hitters in a data stream.

2. Description of the Related Art

Aggregation along hierarchies is a critical summary technique in a large variety of online applications, including decision support (e.g., online analytical processing (OLAP)), network management (e.g., internet protocol (IP) clustering, denial-of-service (DoS) attack monitoring), text (e.g., on prefixes of strings occurring in the text), and extensible markup language (XML) summarization (i.e., on prefixes of root-to-leaf paths in the XML data tree). In such applications, the data is inherently hierarchical and it is desirable to maintain aggregates at different levels of the hierarchy over time in a dynamic fashion.

A heavy hitter (HH) is an element of a data set the frequency of which is no smaller than a user-defined threshold. Conventional algorithms for identifying HHs in data streams maintain summary structures that allow element frequencies to be estimated within a pre-defined error bound. Such conventional HH algorithms, however, do not account for any hierarchy in the data stream. Notably, for data streams where the data is either implicitly or explicitly hierarchical, conventional HH algorithms are ineffective. Accordingly, there exists a need in the art for more efficient processing of data streams having hierarchical data to identify heavy hitters.

### SUMMARY OF THE INVENTION

A method, apparatus, and computer readable medium for processing a data stream is described. In one embodiment, a set of elements of a data stream are received. The set of elements are stored in a memory as a hierarchy of nodes. Each of the nodes includes frequency data associated with either an element in the set of elements or a prefix of an element in the set of elements. A set of hierarchical heavy hitters is then identified among the nodes in the hierarchy. The frequency data of each of the hierarchical heavy hitter nodes, after discounting any portion thereof attributed to a descendent hierarchical heavy hitter node in said set of hierarchical heavy hitter nodes, being greater than or equal to a fraction of the number of elements in the set of elements.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a computer suitable for implementing processes and methods described herein;

FIG. 2 is a block diagram depicting an exemplary embodiment of a data stream to be processed by the invention;

FIG. 3 is a flow diagram depicting an exemplary embodiment of a process for identifying hierarchical heavy hitters in a data stream in accordance with one or more aspects of the invention; and

FIG. 4 is a flow diagram depicting another exemplary embodiment of a process for identifying hierarchical heavy hitters in a data stream in accordance with one or more aspects of the invention.

To facilitate understanding, identical reference numerals have been used, wherever possible, to designate identical elements that are common to the figures.

### DETAILED DESCRIPTION OF THE INVENTION

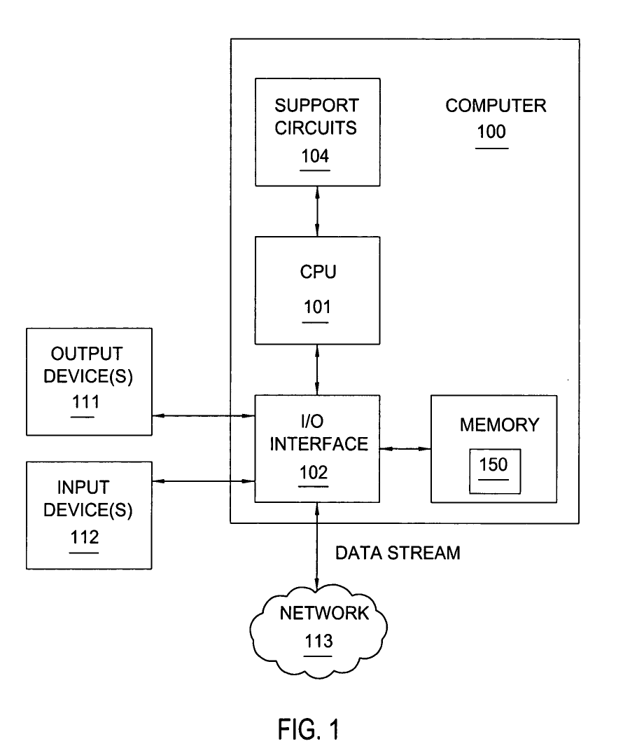

FIG. 1 is a block diagram depicting an exemplary embodiment of a computer 100 suitable for implementing processes and methods described herein. The computer 100 includes a central processing unit (CPU) 101, a memory 103, various support circuits 104, and an I/O interface 102. The CPU 101 may be any type of microprocessor known in the art. The support circuits 104 for the CPU 102 include conventional cache, power supplies, clock circuits, data registers, I/O interfaces, and the like. The I/O interface 102 may be directly coupled to the memory 103 or coupled through the CPU 101. The I/O interface 102 may be coupled to various input devices 112 and output devices 111, such as a conventional keyboard, mouse, printer, display, and the like. In addition, the I/O interface 102 may be adapted to receive a data stream from a source, such as a network 113.

The memory 103 may store all or portions of one or more programs and/or data to implement the processes and methods described herein. Although the invention is disclosed as being implemented as a computer executing a software program, those skilled in the art will appreciate that the invention may be implemented in hardware, software, or a combination of hardware and software. Such implementations may include a number of processors independently executing various programs and dedicated hardware, such as application specific integrated circuits (ASICs).

The computer 100 may be programmed with an operating system, which may be OS/2, Java Virtual Machine, Linux, Solaris, Unix, Windows, Windows95, Windows98, Windows NT, and Windows2000, WindowsME, and WindowsXP, among other known platforms. At least a portion of an operating system may be disposed in the memory 103. The memory 103 may include one or more of the following random access memory, read only memory, magneto-resistive read/write memory, optical read/write memory, cache memory, magnetic read/write memory, and the like, as well as signal-bearing media as described below.

Notably, the data stream input to the I/O interface 102 may be associated with a variety of applications where the data is inherently or explicitly hierarchical, such as network-aware clustering and Denial of Service (DoS) attack monitoring applications. One or more aspects of the invention may be used to identify hierarchical heavy hitters (HHHs) in a data stream. Given a hierarchy and a fraction, φ, HHH nodes comprise all nodes in the hierarchy that have a total number of descendant elements in the data stream no smaller than φ of the total number of elements in the data stream, after discounting descendent nodes that are HHH nodes themselves. This is a superset of the HHs consisting of only data stream elements, but a subset of the HHs over all prefixes of all elements in the data stream. HHHs thus provide a topological “cartogram” of the hierarchical data in the data stream. The identification of HHHs in an input data stream may be performed by software 150 stored in the memory 103.

For example, the goal of network-aware clustering is to identify “groups” (e.g., hosts under the same administrative domain) based on access patterns, in particular, those responsible for a significant portion of a Web site's requests (measured in terms of the number of internet protocol (IP) flows). In a DoS SYN-flooding attack, attackers flood a victim with SYN packets (to initiate transmission control protocol (TCP) sessions) without subsequently acknowledging the victim's SYN-ACK packets with ACK packets to complete the “three-way handshake,” thereby depleting the resources of the victim. Such a DoS attack may be detected when there is a large disparity between the number of SYN and ACK packets received by a host. Such a disparity may be detected by maintaining statistics, for IP address prefixes at different levels of aggregation, of the ratio of the number of ACK and SYN packets. Thus, in such applications, identifying HHH elements and their corresponding frequencies is desirable.

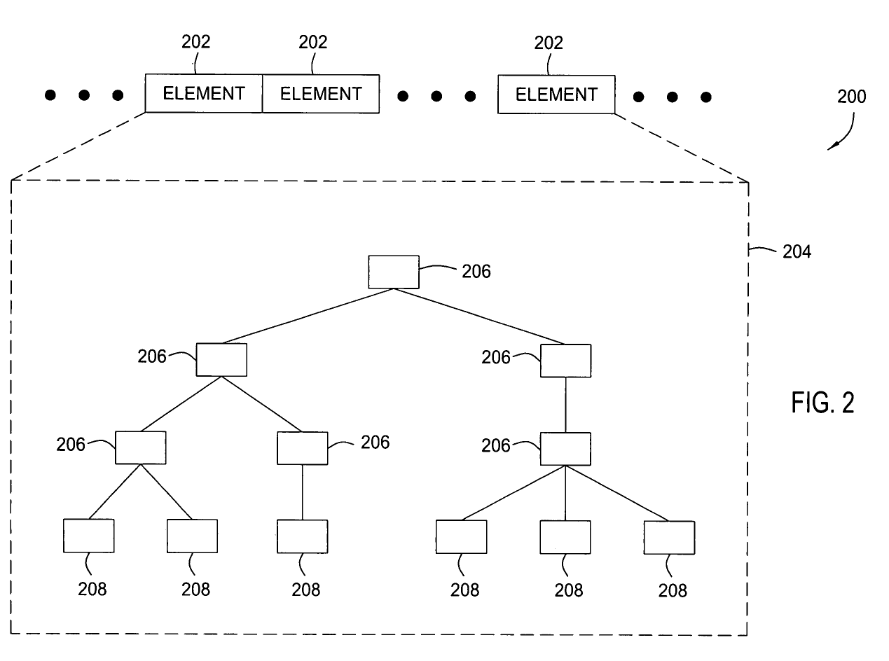

FIG. 2 is a block diagram depicting an exemplary embodiment of a data stream 200 to be processed by the invention. The data stream 200 illustratively comprises a stream of elements 202 (also referred to as “data elements”). The elements 202 of the data stream 200 are associated with a hierarchy 204. Notably, the data elements 202 may be explicitly associated with the hierarchy 204 (e.g., the data elements 202 form a binary tree). Alternatively, the data elements 202 may be implicitly associated with the hierarchy 204. For example, each of the data elements 202 may be a 32-bit internet protocol (IP) address in the form of “xxx.xxx.xxx.xxx.” The hierarchy 204 comprises a set of parent nodes 206 and a set of leaf nodes 208. In one embodiment of the invention, the leaf nodes 208 correspond to the elements 202 of the data stream 200, and the parent nodes 206 correspond to “prefixes” of the elements 202. For example, if the elements 202 are IP addresses, the leaf nodes 208 may correspond to 32-bit IP addresses and the parent nodes 206 may correspond to any of the leading b-bit prefixes of the 32-bit IP addresses, where b ranges from 1 to 31. Alternatively, some of the leaf nodes 208 may correspond to prefixes of the elements 202 in the data stream 200.

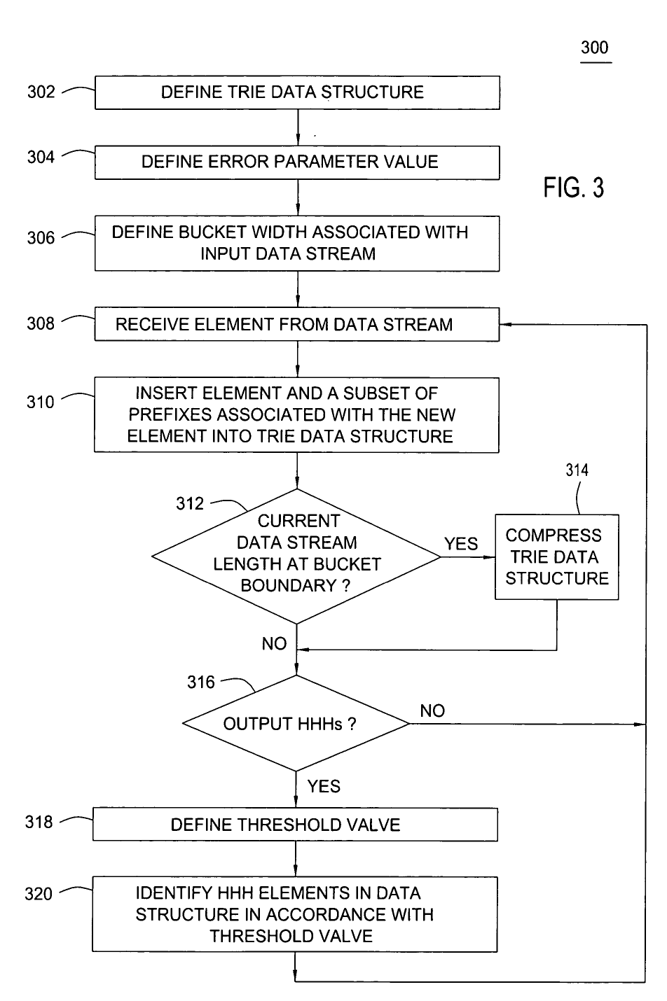

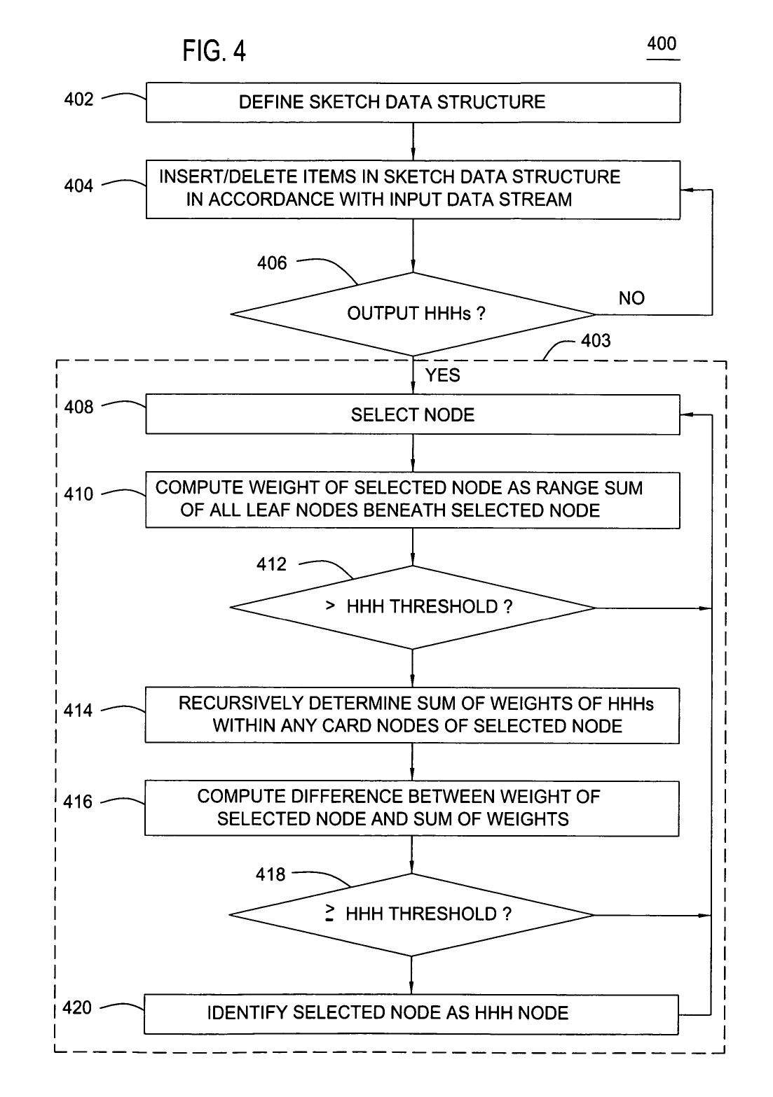

The data stream 200 may be an insert-only stream, such as in a network-aware clustering application, where each IP flow contributes to an element in the data stream 200. Alternatively, the elements 202 of the data stream 200 may be inserted and deleted, such as in a DoS attack monitoring application, where SYN packets are treated as insertions of elements in the data stream, and ACK packets are treated as deletions from the data stream. Embodiments of the invention for processing an insert-only stream are described below with respect to FIG. 3. Notably, for an insert-only stream, sample-based summary structures are maintained with deterministic error guarantees for finding HHHs. Embodiments of the invention for processing an insertion/deletion stream are described below with respect to FIG. 4. For an insertion/deletion data stream, a randomized algorithm is used for finding HHHs with probabilistic guarantees using sketch-based summary structures.

Aspects of the invention described below with respect to FIGS. 3 and 4 may be understood with reference to the following definitions. As referred to herein, a “Heavy Hitter” or HH is defined as follows:
Given a (multi)set S of size N and a threshold φ, a Heavy Hitter (HH) is an element the frequency of which in S is no smaller than └φN┘. Let fₑ denote the frequency of each element, e, in S. Then HH={e|fₑ≧└φN┘}.
   The heavy hitters problem is that of finding all heavy hitters, and their associated frequencies, in a data set. Note that in any data set, there are no more than 1/φ heavy hitters.

As referred to herein, a “Hierarchical Heavy Hitter” or HHH is defined as follows:
Given a (multi)set S of elements from a hierarchical domain D of height h, let elements(T) be the union of elements that are descendants of a set of prefixes, T, of the domain hierarchy. Given a threshold φ, the set of Hierarchical Heavy Hitters of S may be defined inductively. HHH₀, the hierarchical heavy hitters at level zero, are the heavy hitters of S. Given a prefix, p, at level, I, in the hierarchy, define F(p) as Σf(e):

$$e ∈ elements ( \{ p \} ) ⩓ e ∉ elements ( {{⋃}_{l = 0}}^{i - 1} {HHH}_{l} ) .$$

HHHᵢ is the set of Hierarchical Heavy Hitters at level I, that is, the set {p|F(p)≧└φN┘}. The set of Hierarchical Heavy Hitters, HHH, is thus ∪ᵢ₌₀^{h}HHHᵢ.
Note that, since ΣₚF(p)=N, the number of hierarchical heavy hitters is no more than 1/φ.

Consider an example consisting of a multiset, S, of 32-bit IP addresses. Such an example may arise in a network-aware clustering application, where the IP addresses are the source IP addresses associated with individual Web requests. Let the counts of descendents associated with (some of the) IP address prefixes in S, with N=100,000 elements be as follows:
135.207.50.250/24(2003), 135.207.50.250/25(1812), 135.207.50.250/26(1666), 135.207.50.250/27(1492), 135.207.50.250/28(1234), 135.207.50.250/29(1001), 135.207.50.250/30(767), 135.207.50.250/31(404), and 135.207.50.250/32(250),
   where ipaddr/b(c) indicates that the IP address prefix obtained by taking the leading b bits of the IP address ipaddr has a descendant leaf count of c. Using φ=0.01, only 135.207.50.250/29 and 135.207.50.250/24 are HHHs. The former is an HHH because its descendant count exceeds the threshold (100,000*0.01=1000). The latter is an HHH because its descendant count, after discounting the count associated with its descendant HHH 135.207.50.250/29, also exceeds the threshold.

Note that HHHs can include elements in the input, as well as their prefixes, and a prefix may be a heavy hitter without any of its descendants elements being a heavy hitter. In the above example, the (leaf) element 135.207.50.250/32 is not an HHH, but its prefix 135.207.50.250/29 is an HHH. Finding heavy hitters consisting only of elements would hence return too little information. Finding heavy hitters over all prefixes of all elements would return too much information, having little value. This would be a superset of the HHHs, containing not just the HHHs, but also each of its prefixes in the hierarchy. In the above example, this would return all 29 prefixes of 135.207.50.250/29, not all of which are of interest.

As referred to herein, the HHH Problem may be defined as follows:
Given a data stream S of elements from a hierarchical domain D, a threshold φ∈(0,1), and an error parameter ε∈(0,φ), the Hierarchical Heavy Hitter Problem is that of identifying prefixes p∈D, and estimates fₚ of their associated frequencies, on the first N consecutive elements S_{N} of S to satisfy the following conditions—(i) accuracy: f*ₚ−εN≦fₚ≦f*ₚ, where f*ₚ is the true frequency of p in S_{N}; (ii) coverage: All prefixes q not identified as approximate HHHs have Σf*ₑ: e∈elements({q})\hat{ }e∉elements(P)<└N┘, for any supplied φ≧ε, where P is the subset of p's that are descendants of q.
   The above definition only pertains to correctness and does not define anything relating to the “goodness” of a solution to the HHH problem. For example, a set of heavy hitters over all prefixes of the elements would satisfy this definition, as would the full domain hierarchy, but these are not likely to be good solutions. Rather, a good solution is one that satisfies correctness in small space. This is for two reasons: First, for semantics, it is desirable to eliminate superfluous information (e.g., the above example illustrates how heavy hitters over all prefixes of the elements provides too much information, having little value). Second, for efficiency, it is desirable to minimize the amount of space and time required for processing over a data stream. The above notion of correctness closely corresponds to the definition of HHHs, described above. Thus, the size of the set of HHHs is the size of the smallest set that satisfies the correctness conditions of the HHH problem. Note that any data structure that can satisfy the accuracy constraints for φ=ε will satisfy it for all φ≧ε.

Deterministic algorithms for identifying HHHs in an insert-only data stream are now described. Notably, an error parameter is defined in advance and a threshold value may be defined at run-time to output error bounded HHHs above the threshold. FIG. 3 is a flow diagram depicting an exemplary embodiment of a process 300 for identifying hierarchical heavy hitters in a data stream in accordance with one or more aspects of the invention. The process 300 begins at step 302, where a trie data structure is defined. As is well known in the art, a “trie” is a data structure that stores the information about the contents of each node in the path from the root to the node, rather than the node itself. The trie data structure defined at step 302 will comprise a set of tuples corresponding to samples from the input data stream. Each tuple comprises a prefix or data element and auxiliary information. As described more fully below, the auxiliary information comprises an estimated frequency for the associated prefix or element and a maximum possible error in the estimated frequency. For purposes of clarity by example, the present embodiment of the invention is described with respect to a trie data structure. It is to be understood, however, that the invention may use other types of data structures known in the art that simulate a trie data structure.

At step 304, a value for an error parameter is received. The error parameter is described above with respect to the definition of the HHH Problem. At step 306, a bucket width is defined. That is, the data stream is conceptually divided into buckets of data elements, the width of the buckets relates to the number of data elements per bucket. For example, the bucket width may be defined as w=┌1/ε┐, where w is the bucket width and E is the error parameter set in step 304. As each new element is received from the data stream, the current bucket being processed may be determined as b_{current}=└N┘, where b_{current} is the current bucket number and N is the current length of the data stream (i.e., the current number of elements processed).

At step 308, an element is received from the data stream for processing. At step 310, the element and a subset of prefixes associated with the element are inserted in the trie data structure. By “insertion,” it is meant that an entry in the trie data structure is newly created for the element and the subset of prefixes, or a frequency count value for the new element or any of the subset of prefixes is incremented. As described more fully below, the insertion process involves looking-up the new element in the trie data structure. If the element exists (i.e., there is a tuple in the trie data structure corresponding to the element), a count value associated with the estimated frequency of the element is incremented. If the element is not present within the trie data structure, a determination is made as to whether any of the element's prefixes are present in the trie data structure. If a prefix of the element is found in the trie data structure, the element and all prefixes “below” the found prefix are inserted into the trie data structure. If no prefixes are found, the element and all of its prefixes are inserted. Thus, the “subset” of prefixes may comprise no prefixes (e.g., the element is found within the trie data structure), some prefixes (e.g., the element is not found within the trie data structure, but a prefix of the element is found), or all prefixes (e.g., neither the element nor any of its prefixes are found within the trie data structure). Embodiments of the insertion process are described below.

At step 312, a determination is made as to whether the current data stream length is at a bucket boundary. If so, the process 300 proceeds to step 314, where the trie data structure is compressed. Otherwise, the process 300 proceeds to step 316. That is, if one bucket-full data elements has been processed since the last compression at step 314, the data structure is recompressed at step 314. During compression, the space is reduced via merging auxiliary values and deleting. Embodiments of the compression process are described below.

At step 316, a determination is made as to whether HHHs of the data stream are to be output. If not, the process 300 returns to step 308 to receive the next element. Otherwise, the process 300 proceeds to step 318, where a threshold value is defined. At step 320, HHH elements are identified in the data structure in accordance with the threshold value defined at step 318. The process 300 returns to step 308, where the next stream element is received.

Embodiments of the process 300 are now described. In each of the embodiments, a trie data structure, T, is maintained comprising a set of tuples as described above with respect to step 302. Initially, T is empty. Each tuple, denoted as tₑ, comprises a prefix or element, denoted as e, that corresponds to prefixes or elements in the data stream. If tₐ(e) is the parent of tₑ, then a(e) is an ancestor of e in the domain hierarchy (i.e., a(e) is a prefix of e). Associated with each value is a bounded amount of auxiliary information used for determining lower- and upper-bounds on the frequencies of elements whose prefix is e (fₘᵢₙ(e) and fₘₐₓ(e), respectively). As described above, there are two alternating phases of the process 300: insertion and compression. Embodiments for insertion and compression are described in more detail below. At any point, HHHs may be extracted and output given a user-defined threshold, denoted as φ.

In one embodiment of the invention, a direct process for identifying HHHs is employed. The present embodiment is referred to herein as “Strategy 1”. Notably, auxiliary information is obtained in the form of (gₚ,Δₚ) associated with each item p, where the gₚ's are frequency differences between p and its children {e}. Specifically:
gₚ=fₘᵢₙ(p)−Σₑfₘᵢₙ(e).
By tracking frequency differences, rather than actual frequency counts, the invention obviates the need to insert all prefixes for each stream element. Rather, prefixes are inserted only until an existing node in T corresponding to the inserted prefix is encountered. Thus, the invention is “hierarchy-aware.” The quantity fₘᵢₙ(p) may be derived by summing all gₑ's in the subtree of tₚ in T. The quantity fₘₐₓ(p) may be obtained from fₘᵢₙ(p)+Δₚ.

During compression (step 314), the tuples are scanned in postorder and nodes are deleted that satisfy (gₑ+Δₑ≦b_{current}) and have no descendants. Hence, T is a complete trie down to a “fringe.” All t_{q}∉T must be below the fringe and, for these, g_{q}≡fₘᵢₙ(q). Any pruned nodes, t_{q}, must have satisfied (fₘₐₓ(q)≦b_{current}), due to the algorithm, which gives the criteria for correctness:

$${f}_{q}^{*} - {\sum }_{p} {f}_{p}^{*} \leq {f}_{max} ( q ) - {\sum }_{p} {f}_{min} ( p ) = {g}_{q} + {Δ}_{q} \leq ⌊ ɛ N ⌋ .$$

Since values of gₚ in the fringe nodes of T are the same as fₘᵢₙ(P), the data structure for the present embodiment uses exactly the same amount of space as the indirect process described above. The output process (steps 318-320) accepts a threshold, φ, as a parameter and selects a subset of the prefixes in T satisfying correctness. For a given ε, Strategy 1 identifies HHHs using

$$O ( \frac{h}{ɛ} log ( ɛ N ) )$$

space. Pseudo-code algorithms for insertion, compression, and output for Strategy 1 are shown in Appendix A. The output algorithm shown in Appendix A may also be used with Strategies 2 through 4 described below.

In another embodiment, let {d(e)} denote the deleted descendants of a node tₑ. The bounds on the Δₑ's may be improved by tracking the maximum (g_{d(e)}+Δ_{d(e)}) over all d(e)'s. This statistic is denoted as mₑ. Thus, the auxiliary information associated with each element, e, is (gₑ,Δₑ,mₑ), where gₑ and Δₑ are defined as before. The present embodiment is referred to herein as Strategy 2. Pseudo-code algorithms for insertion and compression for Strategy 2 are shown in Appendix B.

It can be shown that that mₑ<b_{current}. The statistic me maintains the largest value of (g_{d(e)}+Δ_{d(e)}) over all deleted d(e)'s. Thus, any new stream element that has ‘e’ as a prefix could not possibly have occurred with frequency more than mₑ. Suppose d(e) was deleted just after block b′<b_{current}. Hence, (g_{d(e)}+Δ_{d(e)}) must have been less than b′ at the time of deletion and therefore (g_{d(e)}+Δ_{d(e)})≦b_{current}. Since the only difference between Strategy 2 and Strategy 1 is that Δₑ's are initialized to mₚ₍ₑ₎, rather than (b_{current}−1), Strategy 2 cannot contain more tuples than Strategy 1. Thus, for a given ε, Strategy 2 identifies HHHs in

$$O ( \frac{h}{ɛ} log ( ɛ N ) )$$

space.

In yet another embodiment, intermediate nodes of T, as well as nodes without descendants, may be deleted. This embodiment is referred to herein as Strategy 3. The auxiliary information associated with each element, e, is (gₑ, Δₑ), where gₑ and Δₑ are defined above. When a new element, e, is inserted, its Δₑ is initialized using the auxiliary information of its closest ancestor in T as gₐ₍ₑ₎+Δₐ₍ₑ₎, requiring only one operation, since none of the e's prefixes are inserted. Pseudo-code algorithms for insertion and compression for Strategy 3 are shown in Appendix C.

It can be shown that Strategy 3 is correct as follows. First, it can be shown that, for any t_{q}∉T, f*_{q}−Σf*ₚ≦b_{current}, for p's that are children of q in T. Therefore, ∀efₘᵢₙ(e)≦f*ₑ≦fₘₐₓ(e), at all time-steps. In addition, if t_{q}∉T, then f*_{q}−Σₚf*ₚ≦b_{current}. For proofs of the aforementioned propositions, the reader is referred to Cormode et al., “Finding Hierarchical Heavy Hitters in Data Streams,” Proc. Of the 29^{th} VLDB Conference, Berlin, Germany, 2003, which is incorporated by reference herein in its entirety.

In yet another embodiment, a hybrid of Strategies 2 and 3 may be employed, referred to herein as Strategy 4. Notably, the control structure of Strategy 3 may be used as a basis, and the auxiliary statistic mₑ from Strategy 2 may be incorporated, to obtain smaller Δ-values. Pseudo-code algorithms for insertion and compression for Strategy 4 are shown in Appendix D.

For purposes of clarity by example, in the embodiments described above (Strategies 1 through 4), it is assumed that data stream elements are leaves of the domain hierarchy. The algorithms described above may be extended to allow prefixes as input elements in the data stream by explicitly maintaining additional counts with each tuple in the summary structure, and using these counts suitably.

In another embodiment of the invention, a sketch-based approach is employed, rather than a deterministic approach as embodied by the process 300 of FIG. 3. The term “sketch” as used herein refers to a data structure on a distribution A[1 . . . U], where A[i] is the number of times “i” is seen in the data stream. It has the following properties: it uses small space, can be maintained efficiently as new items are seen in the data stream, and can be used to estimate parts of the distribution, A, to some precision with high probability. The performance and choice of sketches depends on: (a) whether items are only inserted, or they are both inserted and deleted; (b) whether one seeks range-sum

$${\sum }_{k = i}^{k = j} A [ k ]$$

or only point estimates, in which case i=j; (c) the precision desired and required probability of success; and (d) whether the data stream is well-formed or not. A data stream is “well-formed” if A[i]≧0 at all times and “ill-formed” otherwise. In general, data streams are expected to be well formed, because an item is not deleted unless it was inserted earlier. However, sometimes, as an artifact of subtractions performed by algorithms that use sketches, the underlying data stream may be inferred to be ill-formed. Many different sketches are known in the art that tradeoff space and update times for the features above.

One or more aspects of the invention relate to a sketch process that provides a probabilistic solution to the hierarchical heavy hitter problem, in the data stream model where the input consists of a sequence of insertions and deletions of items. Note that the deterministic algorithms described above (the embodiments of FIG. 3) do not solve this problem, and that they will produce incorrect output on these more general kinds of data streams.

Let the current number of elements of the data stream be n. On receiving a new item, the sketches are updated and the total count, n, is incremented. To find the hierarchical heavy hitters, a top down search is performed on the hierarchy beginning at the root node. The search proceeds recursively, and the recursive procedure run on a node returns the total weight of all hierarchical heavy hitters that are descendents of that node.

Notably, FIG. 4 is a flow diagram depicting another exemplary embodiment of a process 400 for identifying hierarchical heavy hitters in a data stream in accordance with one or more aspects of the invention. The process 400 begins at step 402, where a sketch data structure is defined. At step 404, items in the sketch data structure are inserted and deleted in accordance with the input data stream. The construction of the sketch data structure in accordance with the data stream is described below. At step 406, a determination is made as to whether HHHs are to be identified. If not, the process 400 returns to step 404. Otherwise, the process 400 proceeds to a search process 403.

Notably, the search process 403 begins at step 408, where a node in the hierarchy associated with the elements and prefixes of the data stream is selected for processing. At step 410, a weight of the selected node is computed as a range sum of all leaf nodes beneath the selected node. At step 412, a determination is made as to whether the weight of the selected node is less than the user defined threshold for determining HHHs (i.e., the threshold φ). If not, the process 400 returns to step 408 to select another node in the hierarchy. Otherwise, the process 400 proceeds to step 414.

At step 414, the sum of weights of HHHs within any child nodes of the selected node is recursively computed. That is, the search process 403 is executed with respect to each child node of the node selected at step 408. At step 416, a difference between the weight of the selected node and the sum of weights computed at step 414 is determined. At step 418, a determination is made as to whether the difference computed in step 416 is greater than or equal to the HHH threshold. If not, the process 400 returns to step 408 to select another node in the hierarchy for processing. Otherwise, the process 400 proceeds to step 420. At step 410, the selected node is identified as an HHH node. The process 400 then returns to step 408 to select another node in the hierarchy for processing. Steps 408 through 420 are thus repeated until all nodes are processed.

The process 400 works because of the observation that if there is a HHH in the hierarchy below a node, then the range sum of leaf values must be no less than the threshold of └φn┘. Then any node that meets the threshold is included, after the weight of any HHHs below has been removed. The number of queries made to sketches depends on the height of the hierarchy, h, the maximum branching factor of the hierarchy, d, and the frequency parameter φ as hd/φ, which governs the running time of this procedure.

The sketch needed for the algorithm above needs only to work with insert and delete of items, and be able to estimate the frequency of each node in the tree. In one embodiment, this may be done using the Random Subset Sums, as described in A. C. Gilbert et al., “How to Summarize the Universe: Dynamic Maintenance of Quantiles,” Proc. Of 28^{th} Intl. Conf. on Vary Large Data Bases, pages 454-65, 2002, which is incorporated by reference herein in its entirety. The Random Subset Sums work in the following fashion: subsets are created of the universe so that for any set, the probability that any member of the universe is in that set is ½. A counter is kept for each set, and when a new item arrives, the counters of every set which includes that item are incremented. Departures of items can be incorporated by performing the inverse operation: decrement the counters of every set which includes the item. Those skilled in the art will appreciate that other sketches and associated sketch-based algorithms may also be employed that are similar to Random Subset Sums, such as a count-min sketch as described in Cormode and Muthukrishnan, “Improved Data Stream Summaries: The Count-Min Sketch and its Applications,” Journal of Algorithms, http://dx.doi.org/doi:10.1016/j.jalgor.2003.12.001, Feb. 3, 2004, which is incorporated by reference herein in its entirety.

Point queries for the frequency of item “I” with a pass over the set of counters can then be very quickly answered. If “i” is included in the set and the counter for the set is c, then (2c−n) is an unbiased estimator for the count of i; if i is not in the set, then (n−2c) is an unbiased estimator for count of i. By taking the average of O(1/ε²), such estimates, then the resulting value is correct up to an additive quantity of ±εn, with constant probability. Taking the median of O(log 1/δ) independent repetitions amplifies this to probability (1−δ).

If a sketch is kept for each of the h levels of the hierarchy, then range sums can be computed as point queries. An important detail is how to store the subsets with which the sketches are created. Clearly, explicitly storing random subsets will be prohibitively costly in terms of memory usage. However, for the expectation and variance calculations, it is only required that the sets are chosen with pairwise independence. It therefore suffices to use functions drawn from a family of pairwise independent hash functions, f, mapping from prefixes onto {−1, 1}, which defines the “random subsets”: for set j we compute fⱼ(i): if the result is 1, then i is included in set j, else it is excluded. Such functions can be computed, as the inner product of the binary representation of i with a randomly chosen seed. Putting all this together yields the following result: The above described algorithm uses Random Subset Sums as the sketch to find Hierarchical Heavy Hitters. The space required is

$$O ( \frac{h}{{ɛ}^{2}} log ( 1 / δ ) ) .$$

Searching for the hierarchical heavy hitters requires time

$$O ( \frac{hd}{{ϕɛ}^{2}} log ( 1 / δ ) ) .$$

With probability at least (1−δ), then the output conforms to the requirements of the Hierarchical Heavy Hitters Problem, described above. The time to process an update to the sketches is

$$O ( \frac{h}{{ɛ}^{2}} log ( 1 / δ ) ) .$$

The pseudo-code to implement the above-described sketch-based algorithm is presented in Appendix E. Note that the space and running time of this method depends strongly on the space and time of the sketch procedures. Using different sketch constructions would impact on these costs.

An aspect of the invention is implemented as a program product for use with a computer system. Program(s) of the program product defines functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to illustrative embodiments of the present invention, other and further embodiments of the invention may be devised without departing from the basic scope thereof, and the scope thereof is determined by the claims that follow.

APPENDIX A
Insert (e, c):
01 if tₑ exists then
02 gₑ += c;
03 else
04 Insert (p(e), 0);
05 create tₑ;
06 gₑ = c;
07 Δₑ = b_{current} − 1;
Compress:
01 for each tₑ ∈ T in postorder do
02 if ((tₑ has no descendants) && (gₑ + Δₑ ≦ b_{current}))
then
03 gₚ₍ₑ₎ += gₑ;
04 delete tₑ;
Output (e, Φ):
/* Gₑ = Σₓgₓ of HHH descendants of e */
01 let Gₑ = gₑ for all e;
02 for each tₑ in postorder do
03 if (Gₑ + Δₑ ≧ └φN┘) then
04 print(e);
05 else
06 Gₚ₍ₑ₎ += Gₑ;

APPENDIX B
Insert (e,c):
/* tₐ₍ₑ₎ is the parent node of tₑ */
01 if tₑ exists then
02 gₑ += c;
03 else if tₐ₍ₑ₎ exists then
04 Insert (p(e),0);
05 create tₑ;
06 gₑ = c;
07 Δₑ = mₑ = mₐ₍ₑ₎;
08 else
09 Insert (p(e),0);
10 create tₑ;
11 gₑ = c;
12 Δₑ = mₑ = b_{current} − 1;
Compress:
01 for each tₑ ∈ T in postorder do
02 if ((tₑ has no descendants) && (gₑ+Δₑ≦b_{current})) then
03 gₐ₍ₑ₎+= gₑ;
04 mₐ₍ₑ₎ = max(mₐ₍ₑ₎,gₑ + Δₑ);
05 delete tₑ;

APPENDIX C
Insert (e,c):
/* tₐ₍ₑ₎ is the parent node of tₑ */
/* p(e) is the immediate prefix of e */
01 if tₑ exists then
02 gₑ += c;
03 else if tₐ₍ₑ₎ exists then
04 create tₑ;
05 gₑ = c;
06 Δₑ = gₐ₍ₑ₎ + Δₐ₍ₑ₎;
07 else
08 create tₑ;
09 gₑ = c;
10 Δₑ = b_{current} −1;
Compress:
01 for each tₑ ∈ T in postorder do
02 if (gₑ+ Δₑ ≦ b_{current}) then
03 if (|e|>1) then
04 Insert(p(e), gₑ);
05 delete tₑ;

APPENDIX D
Insert (e,c):
/* tₐ₍ₑ₎ is the parent node of tₑ */
/* p(e) is the immediate prefix of e */
01 if tₑ exists then
02 gₑ += c;
03 else if tₐ₍ₑ₎ exists then
04 create tₑ;
05 gₑ = c;
06 Δₑ = mₑ = mₐ₍ₑ₎;
07 else
08 create tₑ;
09 gₑ = c;
10 Δₑ = mₑ = b_{current} − 1;
Compress:
01 for each tₑ ∈ T in postorder do
02 if (gₑ+Δₑ≦b_{current}) then
03 if (|e|>1) then
04 Insert(p(e), gₑ);
05 mₚ₍ₑ₎ = max(mₚ₍ₑ₎, gₑ + Δₑ);
06 delete tₑ;

APPENDIX E
Insert (e,c):
01 n = n+1;
02 For each level l of the hierarchy
03 For i = 1 to 3log(1/δ), j = 1 to 8/ε²
04 If (f_{i,j}(e) = 1)
05 sum[l][i][j] = sum[l][i][j] + 1;
06 e = p(e);
Delete (e,c):
01 n = n − 1;
02 For each level l of the hierarchy
03 For i = 1 to 3log(1/δ), j=1 to 8/ε²
04 If (f_{i,j}(e) = 1)
05 sum[l][i][j] = sum[l][i][j] − 1;
06 e = p(e);
Weight (p,l): returns a value
01 for i = 1 to 3log(l/δ)
02 t = 0;
03 for j = 1 to 8/ε²
04 t = t + f_{i,j}(p)*(2*sum[l][i][j] − n);
05 avg[i] = t * ε²;
06 return median(avg);
0utput(φ, e, l): returns a value
01 w = Weight(e,l);
02 if w < └φn┘
03 return 0;
04 else for each child c of e
05 W = W + 0utput(φ,c,l+1);
06 if (w − W ≧ └φn┘)
07 print(e);
08 return(w);
09 else
10 return(W);

1. A method of processing a data stream, comprising:
receiving a set of elements of said data stream;
storing a data structure in a memory, said data structure configured to represent said set of elements as a hierarchy of nodes, each of said nodes having frequency data associated with one of: an element in said set of elements or a prefix of an element in said set of elements; and
processing said data structure to identify a set of hierarchical heavy hitter nodes among said nodes, said frequency data of each of said hierarchical heavy hitter nodes, after discounting any portion thereof attributed to a descendant hierarchical heavy hitter node in said set of hierarchical heavy hitter nodes, being greater than or equal to a fraction of the number of elements in said set of elements.

2. The method of claim 1, wherein said data structure comprises a trie data structure.

3. The method of claim 2, wherein said step of storing comprises, for each element in said set of elements, at least one of:
creating at least one node in said hierarchy of nodes; and
incrementing said frequency data of at least one node in said hierarchy of nodes.

4. The method of claim 3, wherein said step of storing further comprises:
compressing said trie data structure by deleting one or more nodes in said hierarchy of nodes where said frequency data thereof is less than a predefined threshold.

5. The method of claim 1, wherein said data structure comprises a sketch-based summary structure.

6. The method of claim 5, wherein said step of storing comprises:
creating a plurality of subsets, each of said plurality of subsets being associated with one or more elements in said set of elements; and
associating a counter with each of said plurality of subsets.

7. The method of claim 6, wherein said step of storing further comprises, for each element in said set of elements, one of:
incrementing said counter associated with each subset of said plurality of subsets having said element; and
decrementing said counter associated with each subset of said plurality of subsets having said element.

8. The method of claim 6, wherein for each subset of said plurality of subsets, a probability that any of said elements in said set of elements is in said subset is a fixed value.

9. Apparatus for processing a data stream, comprising:
means for receiving a set of elements of said data stream;
means for storing a data structure configured to represent said set of elements in a memory as a hierarchy of nodes, each of said nodes having frequency data associated with one of: an element in said set of elements or a prefix of an element in said set of elements; and
means for processing said data structure to identify a set of hierarchical heavy hitter nodes among said nodes, said frequency data of each of said hierarchical heavy hitter nodes, after discounting any portion thereof attributed to a descendant hierarchical heavy hitter node in said set of hierarchical heavy hitter nodes, being greater than or equal to a fraction of the number of elements in said set of elements.

10. The apparatus of claim 9, wherein said data structure is a trie data structure.

11. The apparatus of claim 10, wherein said means for storing comprises:
means for creating at least one node in said hierarchy of nodes; and
means for incrementing said frequency data of at least one node in said hierarchy of nodes.

12. The apparatus of claim 11, wherein said means for storing further comprises:
means for compressing said trie data structure by deleting one or more nodes in said hierarchy of nodes where said frequency data thereof is less than a predefined threshold.

13. The apparatus of claim 9, wherein said data structure is a sketch-based summary structure.

14. The apparatus of claim 13, wherein said means for storing comprises:
means for creating a plurality of subsets, each of said plurality of subsets being associated with one or more elements in said set of elements; and
means for associating a counter with each of said plurality of subsets.

15. A computer readable medium having stored thereon instructions that, when executed by a processor, cause the processor to perform a method of processing a data stream, comprising:
receiving a set of elements of said data stream;
storing a data structure in a memory, said data structure configured to represent said set of elements in a memory as a hierarchy of nodes, each of said nodes having frequency data associated with one of: an element in said set of elements or a prefix of an element in said set of elements; and
processing said data structure to identify a set of hierarchical heavy hitter nodes among said nodes, said frequency data of each of said hierarchical heavy hitter nodes, after discounting any portion thereof attributed to a descendant hierarchical heavy hitter node in said set of hierarchical heavy hitter nodes, being greater than or equal to a fraction of the number of elements in said set of elements.

16. The computer readable medium of claim 15, wherein said data structure is a trie data structure.

17. The computer readable medium of claim 16, wherein said step of storing comprises, for each element in said set of elements, at least one of:
creating at least one node in said hierarchy of nodes; and
incrementing said frequency data of at least one node in said hierarchy of nodes.

18. The computer readable medium of claim 17, wherein said step of storing further comprises:
compressing said trie data structure by deleting one or more nodes in said hierarchy of nodes where said frequency data thereof is less than a predefined threshold.

19. The computer readable medium of claim 15, wherein said data structure is a sketch-based summary structure.

20. The computer readable medium of claim 19, wherein said step of storing comprises:
creating a plurality of subsets, each of said plurality of subsets being associated with one or more elements in said set of elements; and
associating a counter with each of said plurality of subsets.

21. The computer readable medium of claim 20, wherein said step of storing further comprises, for each element in said set of elements, one of:
incrementing said counter associated with each subset of said plurality of subsets having said element; and
decrementing said counter associated with each subset of said plurality of subsets having said element.

22. The computer readable medium of claim 20, wherein for each subset of said plurality of subsets, a probability that any of said elements in said set of elements is in said subset is a fixed value.
